(19) United States
(12) Patent Application Publication
(10) Pub. No.: US 2020/0061814 A1
(43) Pub. Date: Feb. 27, 2020

(54) ROBOT AND ROBOT SYSTEM

(71) Applicant: KAWASAKI JUKOGYO KABUSHIKI KAISHA, Kobe-shi, Hyogo (JP)

(72) Inventor: Kazunori HIRATA, Yao-shi (JP)

(73) Assignee: KAWASAKI JUKOGYO KABUSHIKI KAISHA, Kobe-shi, Hyogo (JP)

(21) Appl. No.: 16/489,251

(22) PCT Filed: Feb. 26, 2018
(86) PCT No.: PCT/JP2018/006995

§ 371 Date: Aug. 27, 2019

(30) Foreign Application Priority Data
Feb. 27, 2017 (JP) 2017-035271

(51) Int. Cl. B25J 9/16; B25J 9/00; B25J 15/02; B25J 15/08; B25J 15/00

(52) U.S. Cl. CPC B25J 9/1612; B25J 9/0087; H02G 1/12; B25J 15/08; B25J 15/0004; B25J 15/0253

(57) ABSTRACT

A robot is a robot configured to convey an elongated object, and includes a first holding part and a second holding part configured to hold the elongated object extending in an up-and-down direction, at least one arm configured to move the first holding part and the second holding part, and a control device. The control device operates the arm so that the first holding part holds the elongated object at a position above a center-of-gravity position of the elongated object, the second holding part holds the elongated object at position below the center-of-gravity position, and the first holding part and the second holding part move while maintaining a state where the first holding part and the second holding part hold the elongated object.

### TECHNICAL FIELD

The present disclosure relates to a robot and a robot system which convey an elongated object, such as a cable.

### BACKGROUND ART

Conventionally, conveyance and given work is performed for an elongated object, such as a cable or chain-like food, in a manufacturing plant of a machine product or food. For example, in a work to remove a covering at an end of a cable, a worker inserts the cable in a given slot formed in a covering removal device to cause a cutting member provided inside the covering removal device to remove a covering layer of the cable (for example, refer to Patent Document 1).

### REFERENCE DOCUMENT OF CONVENTIONAL ART

### Patent Document

[Patent Document 1] JP2000-358308A

### DESCRIPTION OF THE DISCLOSURE

### Problems to be Solved by the Disclosure

If there are a large number of elongated objects used as a work object, a work to convey each one of the elongated objects requires the worker to take an enormous time. For this reason, in order to improve the work efficiency, it is desired to automate the work to convey each one of the elongated objects.

Therefore, one purpose of the present disclosure is to provide a robot and a robot system which can convey each one of a large number of elongated objects, and can shorten time required for conveying the elongated objects.

### SUMMARY OF THE DISCLOSURE

In order to solve the problem described above, a robot according to one aspect of the present disclosure is a robot configured to convey an elongated object, and includes a first holding part and a second holding part configured to hold the elongated object extending in an up-and-down direction, at least one arm configured to move the first holding part and the second holding part, and a control device. The control device operates the arm so that the first holding part holds the elongated object at a position above a center-of-gravity position of the elongated object, the second holding part holds the elongated object at position below the center-of-gravity position, and the first holding part and the second holding part move while maintaining a state where the first holding part and the second holding part hold the elongated object.

According to this structure, many elongated objects can be conveyed one by one. Moreover, since the first holding part not only holds the elongated object at the position above the center-of-gravity position of the elongated object, but the second holding part also holds the elongated object at the position below the center-of-gravity position of the elongated object, it is prevented that the elongated object sways greatly during the conveyance, and therefore, the elongated object can be moved quickly. Therefore, the time required for the conveyance can be shortened.

For example, the elongated object may have flexibility, and the control device may cause the first holding part to hold an upper end part of the elongated object. According to this structure, since the first holding part holds the upper end of the elongated object, it can be prevented that the part of the elongated object, which comes out above the position at which the first holding part holds the elongated object, hangs down.

The arm may include two arms. One of the arms may be a first arm provided with the first holding part at a tip end thereof, and the other arm may be the second arm provided with the second holding part at a tip end thereof. According to this structure, since the first holding part and the second holding part are provided respectively to the separate arms, the first holding part and the second holding part can be moved individually. Therefore, the distance between the first holding part and the second holding part can be changed easily, and they can be applied to conveyance of many elongated objects having different lengths.

The robot may include a rotary device configured to rotate the second holding part. The control device may cause the rotary device to rotate the second holding part holding the elongated object so that the second holding part bends the elongated object. According to this structure, the direction of the lower end part of the elongated object which is the conveying object can be changed easily. Therefore, by using the robot, the lower end part of the elongated object can be easily set in another work device, for example, which performs a work to a lower end part of the elongated object.

The robot may include a third holding part configured to hold the elongated object at position below the position at which the second holding part holds the elongated object, the elongated object being held by the first holding part and the second holding part without being bent by the second holding part. According to this structure, by the third holding part holding the elongated object, the direction of the lower end part of the elongated object can be changed more accurately to the vertically downward.

A robot system according to one aspect of the present disclosure includes the robot including the rotary device and a work device configured to perform a given work to an end part of the elongated object set horizontally. The control device operates the arm so that the rotary device rotates the second holding part while the second holding part holds the elongated object, and a lower end part of the elongated object is set in the work device. According to this structure, the elongated object can be conveyed in the state extending in the up-and-down direction, and the direction of the lower end part of the elongated object can be changed so that the lower end part of the elongated object can be easily set in the work device.

A robot system according to another aspect of the present disclosure includes the robot which further includes a sensor configured to detect that the holding state of the elongated object by the second holding part is canceled, and a calculating device configured to calculate a length of the elongated object. The control device operates the arm so that the second holding part moves downwardly along the elongated object from an initial position separated downwardly from an upper end of the elongated object by a first distance until the sensor detects that the holding state is canceled, the second holding part holding the elongated object relatively movable in a direction, in which the elongated object extends, with respect to the elongated object held by the first holding part at a position above the center-of-gravity position so that the first holding part receives the weight of the elongated object. The calculating device acquires the first distance from the control device, acquires a second distance by which the second holding part moves from the initial position to a position at which the holding state is canceled, and calculates a length of the elongated object based on the first distance and the second distance. According to this structure, the length of the elongated object which is the conveying object can be measured.

### Effect of the Disclosure

According to the present disclosure, each one of the large number of elongated objects can be conveyed, and the time required for conveying the elongated objects can be shortened.

### BRIEF DESCRIPTION OF DRAWINGS

FIG. 1 is a perspective view illustrating the entire configuration of a robot system according to a first embodiment.

FIG. 2 is a schematic view illustrating an outline configuration of a robot illustrated in FIG. 1.

FIG. 3 is a schematic side view illustrating a state where the robot illustrated in FIG. 2 holds a cable.

FIG. 4 is a cross-sectional view taken along a line IV-IV of FIG. 3.

FIG. 5 is a cross-sectional view taken along a line V-V of FIG. 3.

FIG. 6 is a cross-sectional view taken along a line VI-VI of FIG. 3.

FIG. 7 is a block diagram illustrating a configuration of a control system of the robot system according to the first embodiment.

FIG. 8 is a perspective view illustrating a state where the cable is picked out from a cable rack by the robot illustrated in FIG. 1.

FIG. 9 is a perspective view illustrating a state where the cable is conveyed to near a covering removal device by the robot illustrated in FIG. 1.

FIG. 10 is a perspective view illustrating a state where a direction of a lower end part of the cable is changed by the robot illustrated in FIG. 1.

FIG. 11 is a perspective view illustrating a state where the lower end part of the cable is set in the covering removal device by the robot illustrated in FIG. 1.

FIG. 12 is a perspective view illustrating a state where the cable is picked out from the covering removal device by the robot illustrated in FIG. 1, and the cable is held by a third holding part.

FIG. 13 is a perspective view illustrating a state where the lower end part of the cable is dipped in a solder tub by the robot illustrated in FIG. 1.

FIG. 14 is a perspective view illustrating a state where the cable is accommodated in the cable rack by the robot illustrated in FIG. 1.

FIG. 15 is a schematic side view illustrating a state where a robot of the robot system according to a second embodiment holds the cable.

FIG. 16 is a block diagram illustrating a configuration of a control system of the robot system according to the second embodiment.

### MODES FOR CARRYING OUT THE DISCLOSURE

Hereinafter, one embodiment of the present disclosure will be described with reference to the drawings. Note that, throughout the drawings, the same or corresponding parts are assigned with the same reference characters to omit redundant description. Moreover, throughout the drawings, components illustrating the present disclosure are selectively illustrated, and illustration of other components may be omitted.

### First Embodiment

### (Configuration of Robot System)

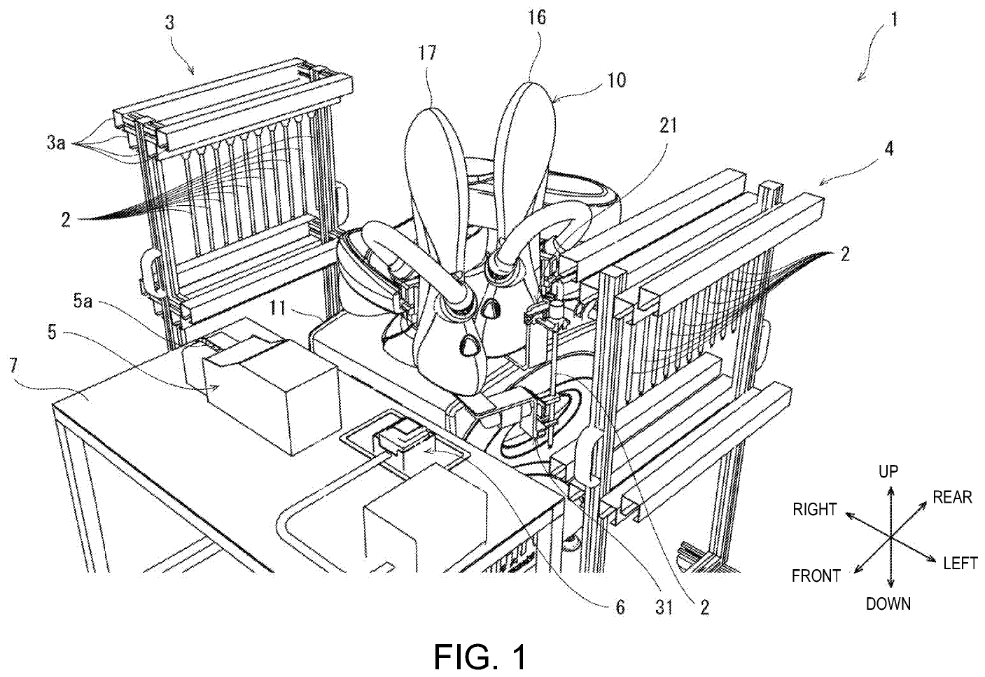

FIG. 1 is a perspective view illustrating the entire configuration of a robot system 1 according to a first embodiment of the present disclosure. The robot system 1 according to this embodiment performs a work to convey a cable 2 which is an elongated object having flexibility, and remove a covering layer at an end of the cable 2. The robot system 1 includes a robot 10, two cable racks 3 and 4, a covering removal device 5, and a solder tub or pod 6.

In this embodiment, the robot 10 is a dual-arm robot having two arms 16 and 17. However, the robot 10 is not limited to this configuration, and, for example, may be a horizontal articulated robot, a vertical articulated robot, etc. which has one arm. The cable racks 3 and 4, the covering removal device 5, and the solder tub 6 are all disposed within a movable range of the robot 10.

The cable rack 3 is disposed on the right side of the robot 10, and the cable rack 4 is disposed on the left side of the robot 10. The two cable racks 3 and 4 have the same configuration, and each provided with a plurality of holding fixtures 3a extending in a front-and-rear direction. Each of the cable racks 3 and 4 accommodates many cables 2 in a suspended manner in which an upper end part of each cable is held by the holding fixture 3a.

Moreover, the covering removal device 5 and the solder tub 6 are placed on a placement table 7 placed in front of the robot 10. The covering removal device 5 performs a covering removal to an end of the cable 2 which is set horizontally. In detail, the covering removal device 5 has a groove 5a into which the end of the cable 2 fits so that the end extends horizontally, and a hole (not illustrated) which is continuous to the groove 5a and opens horizontally. By fitting the end of the cable 2 in the groove 5a and inserting the end horizontally into the hole, the covering layer at the end of the cable 2 is removed. The solder tub 6 applies a solder coating in which solder is applied to the surface of a core wire by soaking the core wire of the cable 2 which is exposed by the covering removal, into a bath of molten solder filled in the solder tub 6.

The robot system 1 of this embodiment performs the covering removal work and the solder coating work to each one of the many cables 2 suspended at the cable rack 3. In detail, the robot 10 picks out one of the cables 2 from the cable rack 3. Next, the robot 10 sets the end of the taken-out cable 2 in the covering removal device 5. The covering removal device 5 performs the covering removal to the end of the set cable 2. The robot 10 inserts the core wire exposed by the covering removal into the solder tub 6. Thus, the solder coating is applied to the end of the cable 2. Finally, the solder coated cable 2 is conveyed to the cable rack 4, where the cable 2 is accommodated in the suspended manner. In the robot system 1, the series of operations described above is repeated for the many cables 2 accommodated in the cable rack 3.

### (Configuration of Robot)

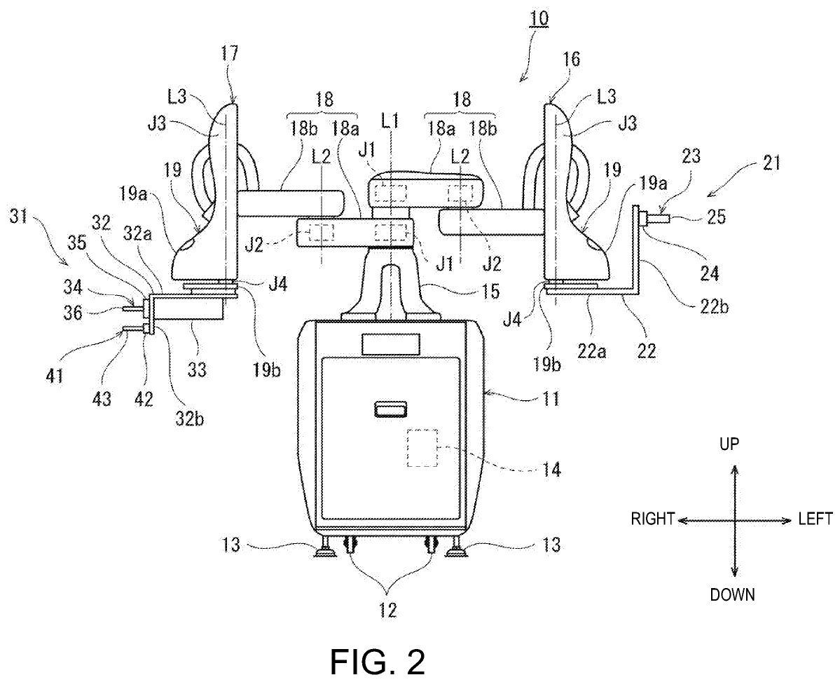

FIG. 2 is a front view schematically illustrating the overall configuration of one example of the robot 10. As illustrated in FIG. 2, the robot 10 includes a carriage 11, and wheels 12 and fixing parts 13 are provided to a bottom surface of the carriage 11. The robot 10 is movable by the wheels 12, and is fixed to the floor by the fixing parts 13. A control device 14 is accommodated in the carriage 11.

Moreover, a base shaft 15 is fixed to an upper surface of the carriage 11. The first arm 16 and the second arm 17 are provided to the base shaft 15 so as to be rotatable about a rotation axis L1 which passes through an axial center of the base shaft 15. Each of the first arm 16 and the second arm 17 is a horizontal articulated robotic arm, and is provided with an arm part 18 and a wrist part 19. Moreover, end effectors 21 and 31 are provided to tip ends of the first arm 16 and the second arm 17, respectively.

Note that, although in this embodiment the first arm 16 and the second arm 17 have substantially the same configuration, except for the end effectors 21 and 31, the first arm 16 and the second arm 17 may have different configurations. Moreover, the first arm 16 and the second arm 17 are configured to operate independently or dependently.

In this example, the arm part 18 is comprised of a first link 18a and a second link 18b. The first link 18a is coupled to the base shaft 15 through a rotary joint J1, and is rotatable about the rotation axis L1 passing through the axial center of the base shaft 15. The second link 18b is coupled to a tip end of the first link 18a through a rotary joint J2, and is rotatable about a rotation axis L2 defined at the tip end of the first link 18a. The rotation axes L1 of the two first links 18a of the first arm 16 and the second arm 17 are on the same straight line, and the first link 18a of the first arm 16 and the first link 18a of the second arm 17 are disposed with a height difference therebetween.

The wrist part 19 is comprised of an elevating part 19a and a rotary part 19b. The elevating part 19a is coupled to a tip end of the second link 18b through a linear-motion joint J3, and is ascendable and descendable with respect to the second link 18b. The rotary part 19b is coupled to a lower end of the elevating part 19a through a rotary joint J4, and is rotatable about a rotation axis L3 defined at the lower end of the elevating part 19a.

Note that the joints J1-J4 of each of the first arm 16 and the second arm 17 are provided with drive motors (not illustrated) as one example of the actuators which relatively rotate, or elevate and lower two members coupled by the respective joints, respectively. The drive motor may be, for example, a servo motor which is servo-controlled by the control device 14. Moreover, the joints J1-J4 are provided with rotation sensors (not illustrated) which detect rotational positions of the drive motors, and current sensors (not illustrated) which detect current for controlling rotation of the drive motors, respectively. The rotation sensor may be, for example, an encoder.

The end effector 21 is coupled to the rotary part 19b of the wrist part 19 of the first arm 16. The end effector 21 includes a frame 22, and a first holding device (first holding part) 23 which holds the cable 2. The frame 22 is comprised of a plate-shaped part 22a which is connected to a lower end of the rotary part 19b of the first arm 16 and spreads horizontally, and a plate-shaped part 22b which rises upwardly from a given end edge of the plate-shaped part 22a. The first holding device 23 is disposed at an upper end part of the plate-shaped part 22b.

Moreover, the end effector 31 is coupled to the rotary part 19b of the wrist part 19 of the second arm 17. The end effector 31 includes a frame 32, a rotary device 33 supported by the frame 32, and a second holding device (second holding part) 34 and a third holding device (third holding part) 41 which hold the cable 2.

The frame 32 is comprised of a plate-shaped part 32a which is connected to a lower end of the rotary part 17b of the second arm 17 and spreads horizontally, and a plate-shaped part 32b extending downwardly from a given end edge of the plate-shaped part 32a. The rotary device 33 is, for example, a drive motor, which rotates the second holding device 34. The rotary device 33 is fixed to a lower surface of the plate-shaped part 32a. The second holding device 34 is disposed at the opposite side of the rotary device 33 with respect to the plate-shaped part 32b. An opening 32c (refer to FIG. 5) is formed in the plate-shaped part 32b, and a shaft part 33a driven by the rotary device 33 passes through the opening 32c, and is coupled to the second holding device 34. The third holding device 41 is disposed below the second holding device 34, and is fixed to the plate-shaped part 32b.

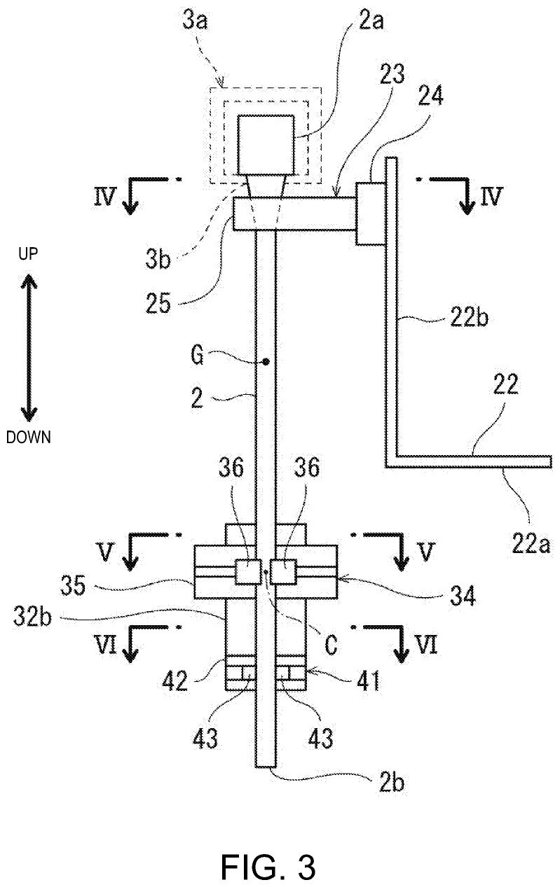

By operating the first arm 16 and the second arm 17 in a state where the end effectors 21 and 31 hold the cable 2, the cable 2 is conveyed. Below, the hold of the cable 2 by the end effectors 21 and 31 is described with reference to FIGS. 3 to 6.

FIG. 3 is a schematic view illustrating the state where the end effectors 21 and 31 hold the cable 2. As illustrated in FIG. 3, the end effectors 21 and 31 hold the cable 2 in a state where the cable 2 extends in the up-and-down direction. Below, an upward of the cable 2 held by the end effectors 21 and 31 in a state where the cable 2 extending in the up-and-down direction is referred to as “up” and a downward of the cable 2 is referred to as “down.”

First, here, a configuration of the cable 2 which is the conveying object, and a state where the cable 2 is accommodated in the cable rack 3, are described. In this embodiment, the cable 2 has an enlarged diameter part 2a at the upper end part. The enlarged diameter part 2a is a part of the cable 2 having a larger diameter than a part of the cable 2 having a constant diameter and extending in the up-and-down direction below the enlarged diameter part 2a. The enlarged diameter part 2a is, for example, a connector. As illustrated by a broken line in FIG. 3, an opening 3b extending in the front-and-rear direction is formed at the bottom of the holding fixture 3a of the cable rack 3 of this embodiment. The cable rack 3 accommodates the cable 2 in the suspended manner by the holding fixture 3a supporting the enlarged diameter part 2a in a state where the cable 2 is inserted in the opening 3b. However, the configuration of the cable 2 and the configuration of the cable rack 3 which accommodates the cable 2 are not limited to the configurations.

As illustrated in FIG. 3, the first holding device 23 holds the cable 2 at a position above a center-of-gravity position G of the cable 2. In this embodiment, the first holding device 23 holds the upper end part of the cable 2. Note that, herein, the term “upper end part” of the cable 2 which is the elongated object means a position at or near the upper end of the cable 2, and the phrase “near the upper end” refers to such a range of the cable 2 that, when the first holding device 23 holds the position, a part of the cable 2 protruding above the position at which the first holding device 23 holds the cable 2 does not hang down.

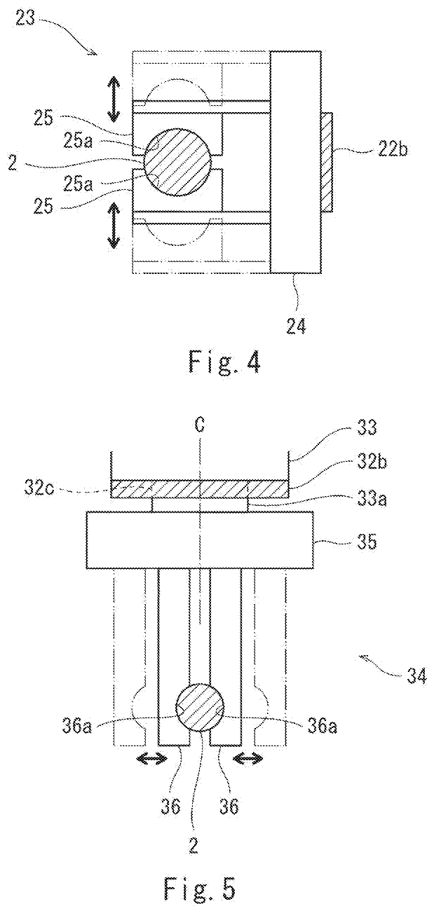

FIG. 4 is a cross-sectional view taken along a line IV-IV of FIG. 3. The first holding device 23 has an actuator 24 supported by the frame 22, and two movable bodies 25 driven by the actuator 24. The two movable bodies 25 are two block bodies extending horizontally in parallel to each other. These two movable bodies 25 oppose horizontally to each other, and grooves 25a having a shape in which the side surface of the cable 2 can fit are formed in the mutually opposing surfaces. The actuator 24 is provided with, for example, a servo motor, and is controlled by the control device 14 to drive the two movable bodies 25 so that the two movable bodies 25 slide in a direction to approach each other and in a direction to separate from each other. By pinching the cable 2 by the grooves 25a of the two movable bodies 25, the first holding device 23 becomes in a holding state where it holds the cable 2.

When conveying the cable 2, the first holding device 23 receives the weight of the cable 2. When the first holding device 23 holds the cable 2, it may grip the cable 2 by pressing the side of the cable 2 by the grooves 25a. Alternatively, at a timing of picking out the cable 2 from the cable rack 3, it is not necessary to bring the grooves 25a in contact with the side of the cable 2, as long as the two grooves 25a approach each other sufficiently for regulating a downward movement of the enlarged diameter part 2a of the cable 2 below the two grooves 25a. Even in this case, after picking out the cable 2 from the cable rack 3, the first holding device 23 receives the weight of the cable 2 by the first holding device 23 regulating the downward movement of the enlarged diameter part 2a.

As illustrated in FIG. 3, the second holding device 34 holds the cable 2 at a position below the center-of-gravity position G of the cable 2. FIG. 5 is a cross-sectional view taken along a line V-V of FIG. 3. The second holding device 34 has an actuator 35, and two movable bodies 36 driven by the actuator 35. The actuator 35 is fixed to the shaft part 33a of the rotary device 33 which is inserted into the opening 32c formed in the plate-shaped part 32b. The two movable bodies 36 are two bar-like bodies extending horizontally in parallel to each other. Grooves 36a having a shape in which the side of the cable 2 can fit are formed in opposing surfaces of the two movable bodies 36. The actuator 35 is provided with, for example, a servo motor, and is controlled by the control device 14 to drive the two movable bodies 36 to slide in a direction to approach each other and separate from each other. By pinching the cable 2 by the grooves 36a of the two movable bodies 36, the second holding device 34 becomes in a holding state where it holds the cable 2.

When conveying the cable 2, the second holding device 34 plays a role of preventing a large sway of the cable 2. For this reason, when conveying the cable 2, the second holding device 34 may not receive the weight of the cable 2. That is, the second holding device 34 may or may not hold the cable 2 vertically, as long as the second holding device 34 can hold the cable 2 horizontally. For example, the grooves 36a of the two movable bodies 36 in the second holding device 34 may have an arc shape in a plan view of a diameter larger than the diameter of the cable 2. In this case, the two grooves 36a may not contact the cable 2 when the two movable bodies 36 approach each other, as long as the two grooves 36a contact the lower end part of the cable 2 when the cable 2 is shaken while being conveyed to regulate a horizontal moving range of the lower end part of the cable 2 (i.e., a range within which the cable 2 sways).

Moreover, the rotary device 33 rotates the second holding device 34 holding the cable 2 so that the second holding device 34 bends the cable 2. In detail, the rotary device 33 is controlled by the control device 14 to rotate the actuator 35 of the second holding device 34 centering on an axis C parallel to an extending direction of the movable bodies 36. By rotating the actuator 35 of the second holding device 34, a direction of the two movable bodies 36 pinching the cable 2 changes, and accordingly, the cable 2 is bent and a direction of the lower end part of the cable 2 is changed. The axis C is located, for example, in the middle of the two movable bodies 36 (refer to FIG. 3).

As illustrated in FIG. 3, the third holding device 41 holds the cable 2 at a position further below the position at which the second holding device 34 holds the cable 2. In more detail, the third holding device 41 holds the cable 2, which is held by the first holding device 23 and the second holding device 34 without being bent by the second holding device 34, at a position below the position at which the second holding device 34 holds the cable 2.

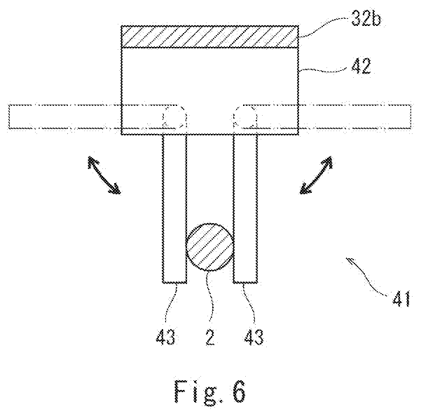

FIG. 6 is a cross-sectional view taken along a line VI-VI of FIG. 3. The third holding device 41 has an actuator 42 supported by the frame 32, and two movable bodies 43 driven by the actuator 42. The two movable bodies 43 are two bar-like bodies extending horizontally. One ends of these two movable bodies 43 are separated horizontally from each other by a width equivalent to the diameter of the cable 2, and are pivotably supported by the actuator 42. The actuator 42 is provided with, for example, a servo motor, and is controlled by the control device 14 to rotate the two movable bodies 43 so that the two movable bodies 43 become in a parallel state, or the other ends of the movable bodies 43 separate from each other to open. When the two movable bodies 43 become in parallel to each other and pinch the cable 2, the third holding device 41 becomes in a holding state where it holds the cable 2.

The third holding device 41 plays a role for more accurately turning the direction of the lower end part of the cable 2 into vertically downward. For example, after the rotary device 33 operates to bend the cable 2, the third holding device 41 corrects the direction of the cable 2 which resumes the original state. That is, as described above, the cable 2 is bent when the rotary device 33 rotates the second holding device 34. Here, even when the rotary device 33 rotates the second holding device 34 to the opposite direction to again return it to the original position, the direction of the lower end part of the cable 2 may be offset slightly from the vertically downward. Alternatively, for example, if the cable 2 was originally bent gently, the extending direction of the cable 2 deviates gradually from the position at which the second holding device 34 holds the cable 2, i.e., from the vertically downward, as it goes toward a lower end 2b. Also in these cases, the third holding device 41 holds the cable 2 by pinching the cable 2 in the same direction as the direction in which the second holding device 34 pinches the cable 2 so that the direction of the lower end part of the cable 2 approaches the vertically downward.

When conveying the cable 2, the third holding device 41 may or may not receive the weight of the cable 2. For example, the third holding device 41 may or may not grip the cable 2 so that the side of the cable 2 is pressed and pinched by the two movable bodies 43. Moreover, the third holding device 41 may not hold the cable 2 horizontally when conveying the cable 2, and for example, the third holding device 41 may hold the cable 2 only after the bending work of the cable 2 by operating the rotary device 33.

Note that, in this embodiment, as illustrated in FIG. 3, the direction in which the first holding device 23 pinches the cable 2 intersects perpendicularly with the direction in which the second holding device 34 and the third holding device 41 pinch the cable 2. However, the directions are not limited to the configuration, and the direction in which the first holding device 23 pinches the cable 2 may be in agreement with or may intersect the direction in which the second holding device 34 and the third holding device 41 pinch the cable 2.

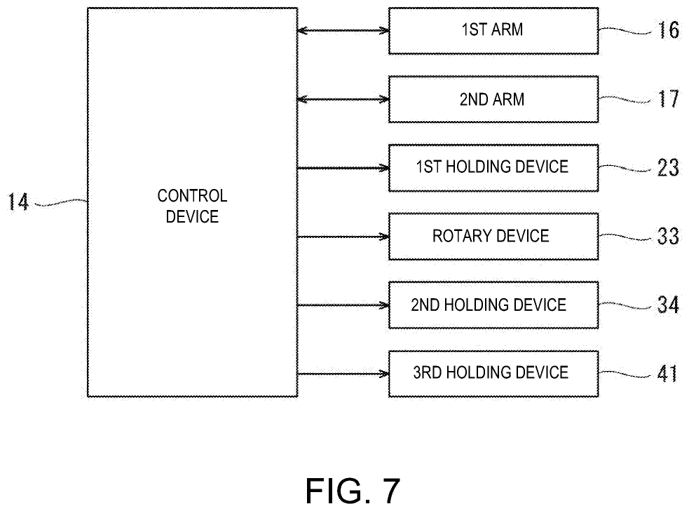

FIG. 7 is a block diagram illustrating a configuration of a control system of the robot system 1. The control device 14 illustrated in FIG. 7 is communicatably connected to the first arm 16, the second arm 17, the first holding device 23, the rotary device 33, the second holding device 34, and the third holding device 41 of the robot 10. The control device 14 is a so-called computer, and has a processor, such as a CPU, and a memory, such as a ROM and a RAM (none of them is illustrated). A control program executed by the control device 14, various fixed data, etc. are stored in the memory. The processor transmits and receives data to/from an external device. Moreover, the processor inputs detection signals from various sensors and outputs a control signal to each controlled object. In the control device 14, by the processor reading and executing software, such as the program stored in the memory, processings for controlling various operation of the robot system 1 are performed. Note that the control device 14 may execute each processing by a centralized control of a sole computer, or may execute each processing by a distributed control of a collaboration of a plurality of computers. Moreover, the control device 14 may be comprised of a microcontroller, a programmable logic controller (PLC), etc.

### (Method of Operating Robot)

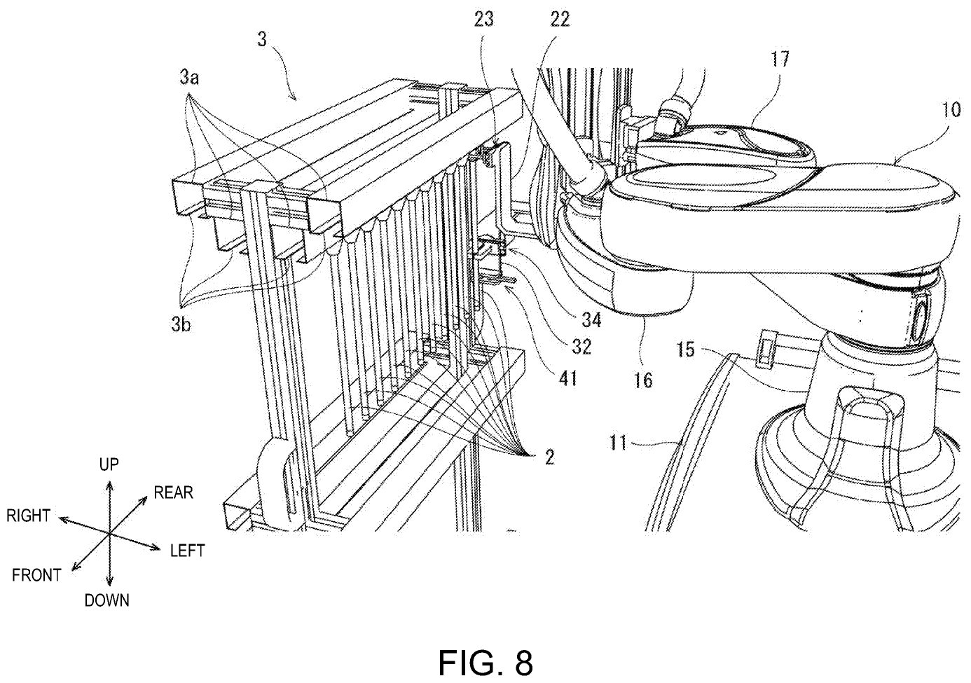

Next, a method of operating the robot 10 in the robot system 1 according to this embodiment is described with reference to FIGS. 8 to 14. This operating method is implemented by the control device 14.

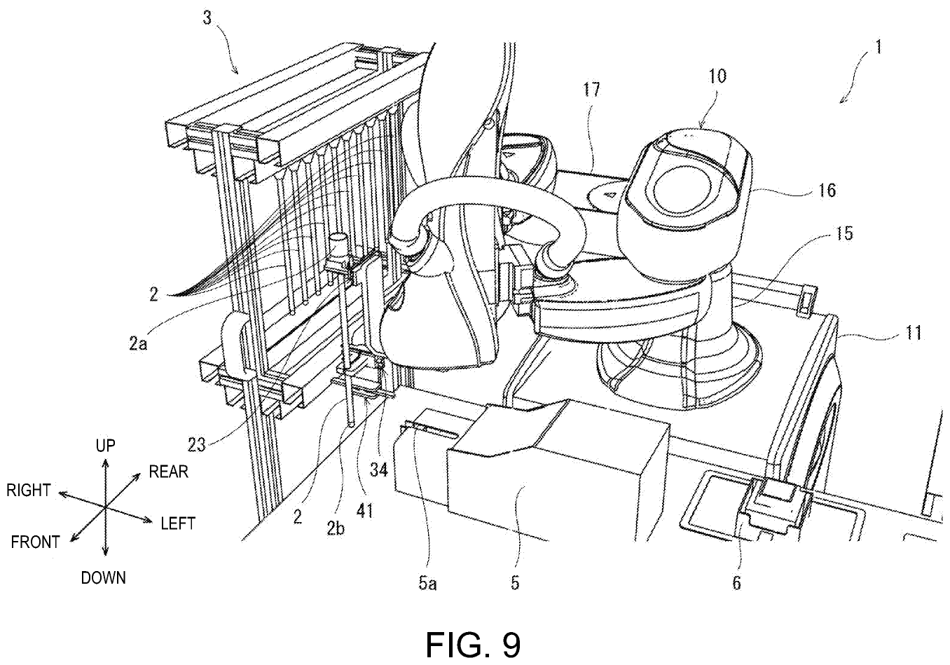

First, as illustrated in FIG. 8, the robot 10 picks out one of the cables 2 from the cable rack 3, and as illustrated in FIG. 9, conveys the cable 2 to near the covering removal device 5.

In detail, the control device 14 operates the first arm 16 so that the first holding device 23 moves to a position at which the first holding device 23 can hold the upper end part of the cable 2, and operates the second arm 17 so that the second holding device 34 moves to a given position below the position at which the first holding device 23 holds the cable 2. Then, the control device 14 sends signals to the actuators 24 and 35 to cause the first holding device 23 and the second holding device 34 to hold the cable 2. Note that, at this timing, although the control device 14 does not cause the third holding device 41 to hold the cable 2, it may cause the third holding device 41 to hold the cable 2.

When the hold is finished, the control device 14 picks out one of the cables 2 from the cable rack 3, and operates the first arm 16 and the second arm 17 so that the cable 2 is conveyed to the position near the covering removal device 5, as illustrated in FIG. 9. At this time, the control device 14 operates the first arm 16 and the second arm 17 so that the first holding device 23 and the second holding device 34 which hold the cable 2 may move while maintaining a spatial relationship therebetween.

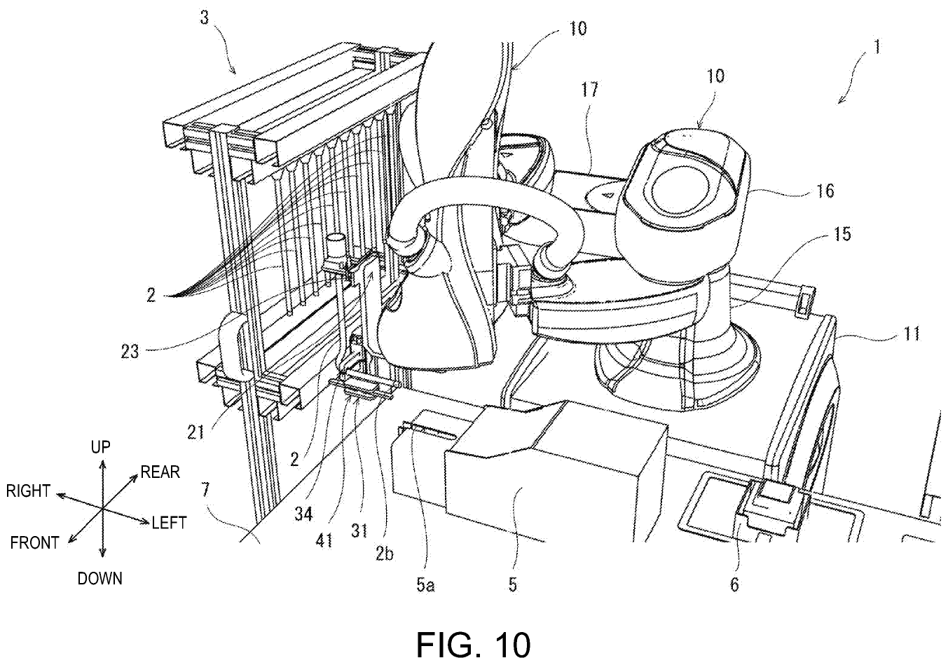

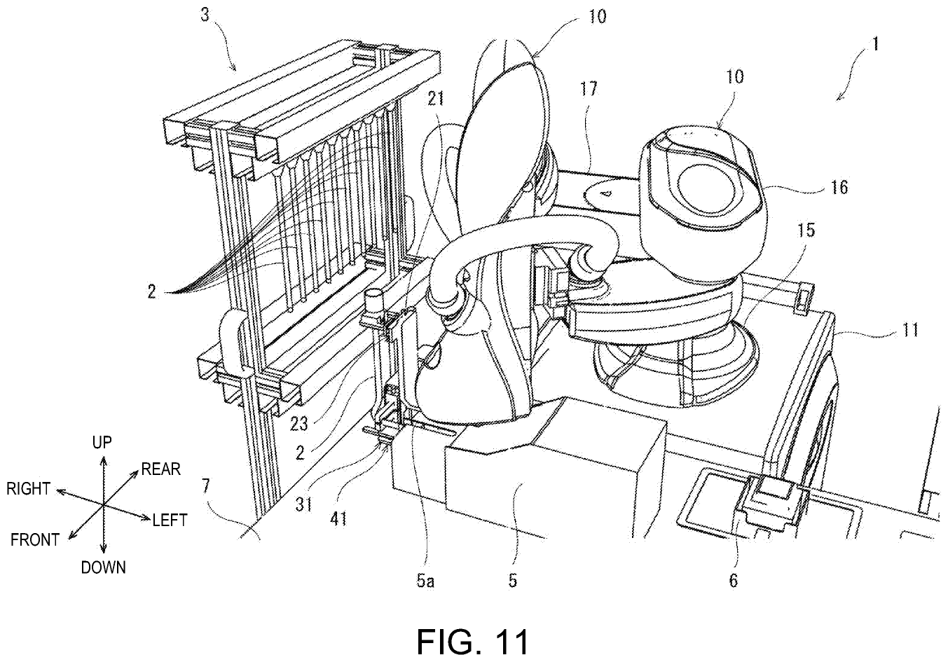

Subsequently, as illustrated in FIG. 10, the robot 10 changes the direction of the lower end part of the conveyed cable 2 into the horizontal direction, and then, as illustrated in FIG. 11, the lower end part of the cable 2 is set in the covering removal device 5.

In detail, the control device 14 sends a signal to the rotary device 33 to rotate the second holding device 34 holding the cable 2 by 90° centering on an axis parallel to the direction in which the movable body 36 extends. Thus, the direction of the lower end part of the cable 2 is changed from the vertically downward to approach the horizontal direction. Then, the control device 14 operates the first arm 16 and the second arm 17 so that the cable 2 moves until the lower end part of the cable 2 is set in the covering removal device 5.

Note that the rotating angle of the second holding device 34 holding the cable 2 by the control device 14 is not limited to 90°, and may be changed suitably. For example, as long as the lower end 2b of the cable 2 can be guided in the given direction, while bringing the lower end 2b of the cable 2 in contact with the groove 5a of the covering removal device 5, the rotating angle of the second holding device 34 may be smaller. For example, if a degree of hang down of the cable 2 becomes larger as it goes to the lower end 2b from the hold position by the second holding device 34, the rotating angle of the second holding device 34 may be increased to bring the direction of the cable 2 near the lower end 2b closer to the horizontal direction as much as possible.

Moreover, in order to prevent a tension occurring in the cable 2 when rotating the second holding device 34, the control device 14 may operate the second arm 17 so that the second holding device moves slightly upward, while causing the rotary device 33 to rotate the second holding device 34.

When the cable 2 moves to the set position of the covering removal device 5, the covering removal device 5 performs the covering removal to the lower end 2b of the cable 2. The covering removal device 5 may be provided with a sensor which detects that the cable 2 is set to the set position, or may start the covering removal based on a detection signal of the sensor. Alternatively, the covering removal device 5 may start the covering removal by being sent from the control device 14 a signal which informs the cable 2 being set to the set position.

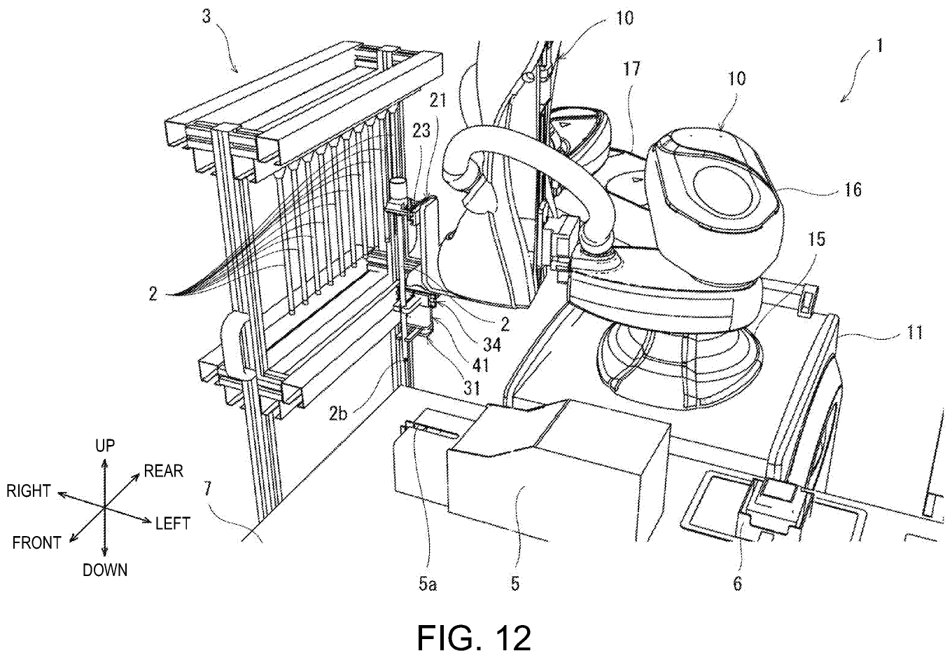

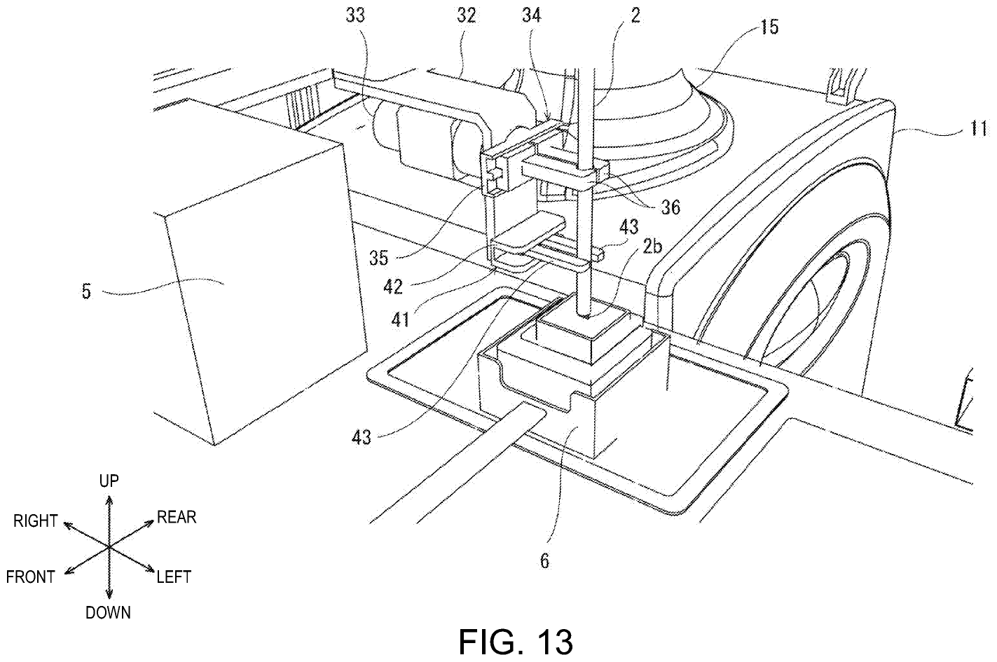

When the covering removal is finished, the robot 10 takes out the cable 2 from the set position of the covering removal device 5, and then, as illustrated in FIG. 12, returns the direction of the lower end part of the cable 2 to the vertically downward, and as illustrated in FIG. 13, dips the exposed core wire at the lower end 2b of the cable 2 into the solder tub 6.

In detail, the control device 14 operates the first arm 16 and the second arm 17 so that the cable 2 is conveyed from the set position of the covering removal device 5 to a given position. Then, the control device 14 sends a signal to the rotary device 33 to rotate it by 90° to the opposite direction from the previous rotating direction to return the direction of the lower end part of the cable 2 to the vertically downward. Further, as illustrated in FIG. 12, the control device 14 sends a signal to the actuator 42 to cause the third holding device 41 to hold the cable 2.

Then, the control device 14 operates the first arm 16 and the second arm 17 so that the core wire of the lower end 2b of the cable 2 is dipped in the solder tub 6. Thus, the solder coating in which solder is stuck on the surface of the core wire is performed.

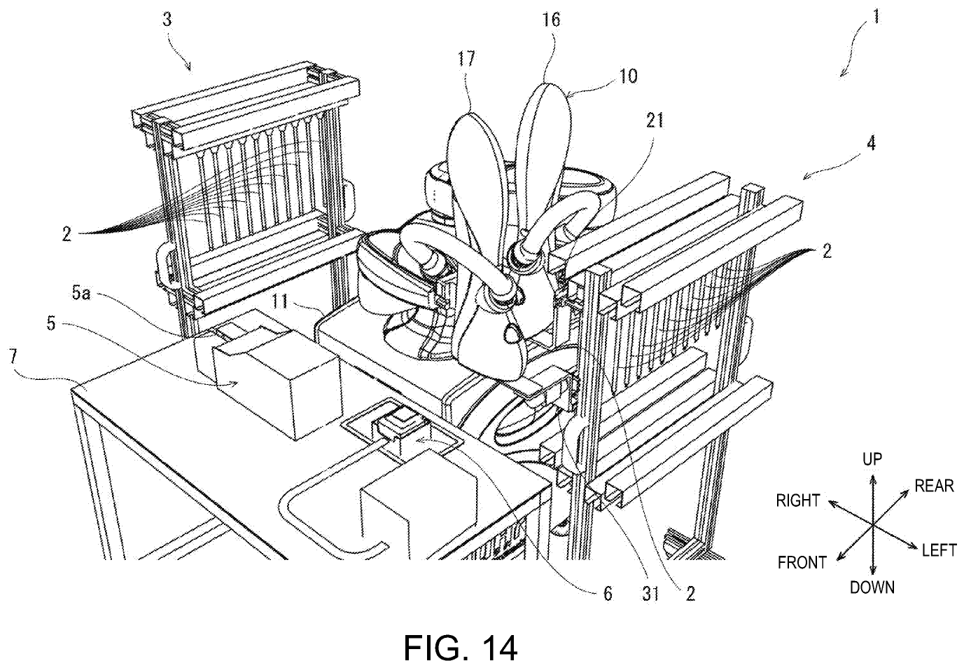

Finally, as illustrated in FIG. 14, the solder coated cable 2 is conveyed to the cable rack 4, and is accommodated in the cable rack 4 in the suspended manner. The series of operation is repeated for the many cables 2 accommodated in the cable rack 3.

By the robot 10 according to this embodiment, the many cables 2 can be conveyed one by one. Moreover, since the first holding device 23 not only holds the cable 2 at the position above the center-of-gravity position G of the cable 2, but the second holding device 34 also holds the cable 2 at the position below the center-of-gravity position G of the cable 2, it is prevented that the cable 2 sways greatly during the conveyance, and therefore, the cable 2 can be moved quickly. Therefore, the time required for the conveyance can be shortened.

Moreover, in this embodiment, since the first holding device 23 holds the upper end part of the cable 2 having flexibility, it can be prevented that the part of the cable 2, which comes out above the position at which the first holding device 23 holds the cable 2, hangs down.

Moreover, in this embodiment, since the first holding device 23 and the second holding device 34 are provided respectively to the separate arms 16 and 17, the first holding device 23 and the second holding device 34 can be moved individually. Therefore, the distance between the first holding device 23 and the second holding device 34 can be changed easily, and they can be applied to conveyance of many cables 2 having different lengths.

Moreover, in this embodiment, since the control device 14 causes the rotary device 33 to rotate the second holding device 34 holding the cable 2 so that the second holding device 34 bends the cable 2, the direction of the lower end part of the cable 2 which is the conveying object can be changed easily. Therefore, by using the robot 10, the lower end part of the cable 2 can be easily set in the covering removal device 5 into which the end of the cable 2 can be inserted horizontally.

In this embodiment, the cable 2 is held by the first holding device 23 and the second holding device 34, without being bent by the second holding device 34, and the third holding device 41 holds the cable 2 at the position below the position at which the second holding device 34 holds the cable 2. Therefore, the direction of the lower end part of the cable 2 can be changed more accurately to the vertically downward.

Moreover, the third holding device 41 is configured to rotate the two movable bodies 43 which pinch the cable 2. Therefore, the third holding device 41 can be realized by the compact configuration, without the lower end part of the cable 2 interfering with the movable body 43 when the rotary device 33 drives and changes the direction of the lower end part of the cable 2.

### Second Embodiment

Next, a second embodiment is described. Below, description of the configuration common to the first embodiment is omitted, and only different configuration is described.

In the robot system 1 according to the second embodiment, the length of the cable 2 which is the conveying object is measured. The robot system 1 according to this embodiment includes the robot 10 having a sensor 51, and a calculating device 52 which calculates the length of the cable 2.

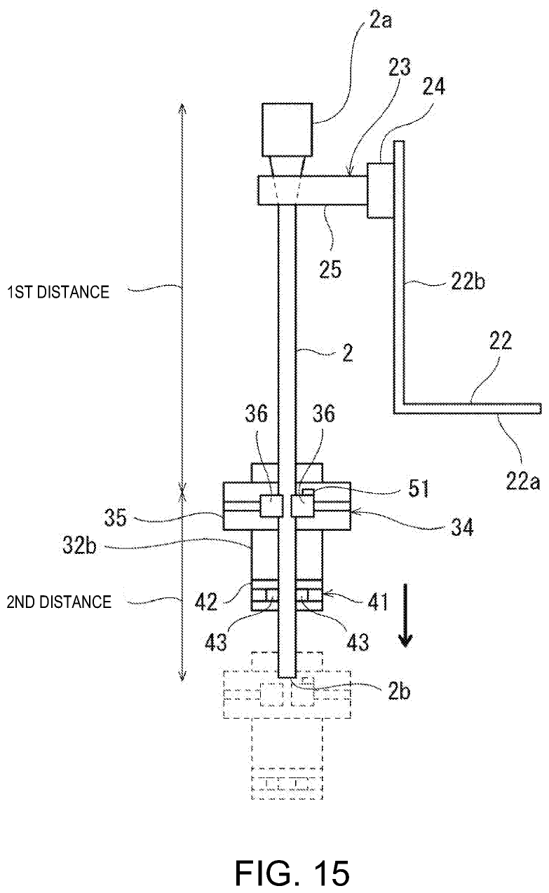

FIG. 15 is a view schematically illustrating a state where the end effectors 21 and 31 of the robot 10 according to this embodiment hold the cable 2. In addition to a similar configuration to the first embodiment, in the robot 10 of this embodiment, the sensor 51 is provided to the second holding device 34. The sensor 51 detects whether the second holding device 34 is in the state where it holds the cable 2. The sensor 51 is, for example, a proximity sensor, a contact sensor, etc.

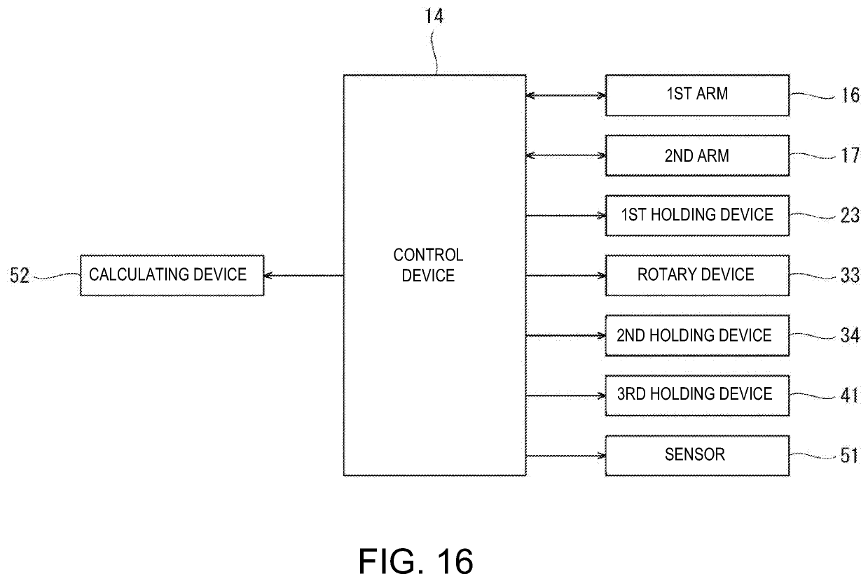

FIG. 16 is a block diagram illustrating a configuration of a control system of the robot system 1 according to this embodiment. In addition to the configuration of the first embodiment illustrated in FIG. 7, the sensor 51 and the calculating device 52 are communicatably connected to the control device 14 illustrated in FIG. 16.

Next, a method of operating the robot 10 in the robot system 1 according to this embodiment is described with reference to FIG. 15. This operating method is implemented by the control device 14.

First, the control device 14 operates the first arm 16 so that the first holding device 23 moves to the position where the first holding device 23 can hold the upper end part of the cable 2. Moreover, the control device 14 operates the second arm 17 so that the second holding device 34 moves to the position (initial position) separated downwardly from the upper end of the cable 2 by a first distance. Moreover, the control device 14 sends the first distance to the calculating device 52.

Next, the control device 14 sends a signal to the actuator 24 to cause the first holding device 23 to hold the upper end part of the cable 2 so that the first holding device 23 receives the weight of the cable 2. Moreover, the control device 14 sends a signal to the actuator 35 to cause the second holding device 34 to hold the cable 2 so as to be relatively movable in the extending direction of the cable 2.

Then, the control device 14 operates the second arm 17 so that the second holding device 34 moves downwardly from the initial position along the cable 2 until the sensor 51 detects that the holding state is canceled. The control device 14 sends to the calculating device 52 a second distance by which the second holding device 34 moved from the initial position to the position at which the holding state is canceled. The calculating device 52 calculates the length of the cable 2 based on the first distance and the second distance.

Also in this embodiment, a similar effect to the first embodiment can be acquired. Further, in this embodiment, the length of the cable 2 which is the conveying object can be measured.

### Other Embodiments

The present disclosure is not limited to the embodiments described above, but various modifications are possible without departing from the scope of the present disclosure.

For example, although in the above embodiments the elongated object which is the conveying object is the cable 2, it is not limited to this configuration, and the elongated object which is the conveying object may be, for example, food, such as a sausage, or a string material, such as a rope. Moreover, the elongated object conveyed in the present disclosure is not limited to the flexible object, but may have some rigidity. For example, the elongated object which is the conveying object of the present disclosure may be a wire rod made of metal, such as a wire, or a bar made of resin or plastic, or a tubing or piping material.

Moreover, although in the above embodiments the first holding device 23 and the second holding device 34 are provided to the separate arms 16 and 17, respectively, the first holding device 23 and the second holding device 34 may be provided to one arm.

Moreover, although in the first embodiment the rotary device 33 is provided to the second arm 17, the robot 10 may not be provided with the rotary device 33, if the cable 2 does not need to be bent in the work performed by the robot system. Moreover, the robot 10 may not be provided with the third holding device 41. Moreover, in this embodiment, the first holding device 23 may not hold the upper end part of the cable 2, as long as it holds the cable 2 at a position above the center-of-gravity position G of the cable 2.

Moreover, although in the above embodiments the first holding device 23 and the second holding device 34 slide the movable bodies 25 and 36, respectively, and the third holding device 41 rotates the movable body 43, it is not limited to this configuration. The first holding device 23 and the second holding device 34 may rotate the movable bodies 25 and 36, respectively, and the third holding device 41 may slide the movable body 43.

Moreover, although in the above embodiments the elongated object which is the cable 2 is held and conveyed by actuating the movable body 26 of the first holding device 23 and actuating the movable body 36 of the second holding device 34, the holding part which holds the elongated object is not limited to such a configuration. For example, if a hole is formed in an upper end part of the elongated object, the first arm 16 may be provided with a hook which opens upwardly, as the first holding part, instead of the first holding device 23. In this case, the upper end part of the elongated object may be held by engaging the hook as the first holding part with the hole in the upper end part of the elongated object. Moreover, the second arm 17 may be provided with a hook which opens to a given horizontal direction, as the second holding part, instead of the second holding device 34. In this case, the elongated object may be held by engaging the hook as the second holding part with a side surface of the elongated object to regulate the horizontal movement during the conveyance of the cable.

### DESCRIPTION OF REFERENCE CHARACTERS

1: Robot System

2: Cable

5: Covering Removal Device

10: Robot

14: Control Device

16: First Arm

17: Second Arm

23: First Holding Device (First Holding Part)

33: Rotary Device

34: Second Holding Device (Second Holding Part)

41: Third Holding Device (Third Holding Part)

51: Sensor

52: Calculating Device

1. A robot configured to convey an elongated object, comprising:
a first holding part and a second holding part configured to hold the elongated object extending in an up-and-down direction;
at least one arm configured to move the first holding part and the second holding part; and
a control device,
wherein the control device operates the arm so that the first holding part holds the elongated object at a position above a center-of-gravity position of the elongated object, the second holding part holds the elongated object at position below the center-of-gravity position, and the first holding part and the second holding part move while maintaining a state where the first holding part and the second holding part hold the elongated object.

2. The robot of claim 1, wherein the elongated object has flexibility, and the control device causes the first holding part to hold an upper end part of the elongated object.

3. The robot of claim 1, wherein the arm includes two arms, one of the arms is a first arm provided with the first holding part at a tip end thereof, and the other arm is a second arm provided with the second holding part at a tip end thereof.

4. The robot of claim 1, further comprising a rotary device configured to rotate the second holding part,
wherein the control device causes the rotary device to rotate the second holding part holding the elongated object so that the second holding part bends the elongated object.

5. The robot of claim 4, further comprising a third holding part configured to hold the elongated object at position below the position at which the second holding part holds the elongated object, the elongated object being held by the first holding part and the second holding part without being bent by the second holding part.

6. A robot system, comprising:
the robot of claim 4; and
a work device configured to perform a given work to an end part of the elongated object set horizontally,
wherein the control device operates the arm so that the rotary device rotates the second holding part while the second holding part holds the elongated object, and a lower end part of the elongated object is set in the work device.

7. A robot system, comprising:
the robot of claim 1 further comprising a sensor configured to detect that the holding state of the elongated object by the second holding part is canceled; and
a calculating device configured to calculate a length of the elongated object,
wherein the control device operates the arm so that the second holding part moves downwardly along the elongated object from an initial position separated downwardly from an upper end of the elongated object by a first distance until the sensor detects that the holding state is canceled, the second holding part holding the elongated object relatively movable in a direction, in which the elongated object extends, with respect to the elongated object held by the first holding part at a position above the center-of-gravity position so that the first holding part receives the weight of the elongated object, and
wherein the calculating device acquires the first distance from the control device, acquires a second distance by which the second holding part moves from the initial position to a position at which the holding state is canceled, and calculates a length of the elongated object based on the first distance and the second distance.
